(19) United States
(12) Patent Application Publication
(10) Pub. No.: US 2021/0220883 A1
(43) Pub. Date: Jul. 22, 2021

(54) CONTROL APPARATUS OF TANDEM ROLLING MILL

(71) Applicant: TOSHIBA MITSUBISHI-ELECTRIC INDUSTRIAL SYSTEMS CORPORATION, Chuo-ku (JP)

(72) Inventor: Minoru TACHIBANA, Tokyo (JP)

(73) Assignee: TOSHIBA MITSUBISHI-ELECTRIC INDUSTRIAL SYSTEMS CORPORATION, Chuo-ku (JP)

(21) Appl. No.: 16/967,460

(22) PCT Filed: Dec. 12, 2018
(86) PCT No.: PCT/JP2018/045752

§ 371 Date: Aug. 5, 2020

(51) Int. Cl. B21B 37/46

(52) U.S. Cl. CPC B21B 37/46

(57) ABSTRACT

A control apparatus of a tandem rolling mill includes a speed command output unit configured to temporarily output a speed command value to each of a plurality of stands before a tandem rolling mill is activated while in a state where a rolled material is sandwiched between the plurality of stands, and a Droop amount setting unit configured to set a Droop amount set value of the stand smaller toward rear stage of the plurality of stands, during a period in which the speed command output unit temporarily outputs the speed command value. Including the configuration makes it possible to more surely prevent rupture of the rolled material. The control apparatus of the tandem rolling mill makes it possible to more surely prevent rupture of a rolled material.

### FIELD

The present invention relates to a control apparatus of a tandem rolling mill.

### BACKGROUND

PTL 1 discloses a control apparatus of a tandem rolling mill. According to the control apparatus, rupture of a rolled material may be prevented with use of a Droop function (motor speed command reduction rate with respect to motor current of 100%) with respect to a plurality of stands when the tandem rolling mill is activated.

### CITATION LIST

### Patent Literature

[PTL 1] JP S60-3910 A

### SUMMARY

### Technical Problem

The control apparatus disclosed in PTL 1, however, does not consider difference in a load due to mechanical rattle among the plurality of stands when the tandem rolling mill is activated. Therefore, a large difference in speed of rolls may in some cases occur between the adjacent stands due to the Droop function. As a result, the rolled material ruptures in some cases.

The present invention has been made to solve the above-described issues. An object of the present invention is to provide a control apparatus of a tandem rolling mill that makes it possible to more surely prevent rupture of a rolled material.

### Solution to Problem

A control apparatus of a tandem rolling mill according to the present invention includes a speed command output unit configured to temporarily output a speed command value to each of a plurality of stands before a tandem rolling mill is activated while in a state where a rolled material is sandwiched between the plurality of stands, and a Droop amount setting unit configured to set a Droop amount set value of the stand smaller toward rear stage of the plurality of stands, during a period in which the speed command output unit temporarily outputs the speed command value.

A control apparatus of a tandem rolling mill according to the present invention includes a torque command output unit configured to temporarily output a torque command value to each of a plurality of stands before a tandem rolling mill is activated while in a state where a rolled material is sandwiched between the plurality of stands, and a Droop amount setting unit configured to set a Droop amount set value of the stand smaller toward rear stage of the plurality of stands, during a period in which the torque command output unit temporarily outputs the torque command value.

### Advantageous Effects of Invention

According to the invention, the Droop amount set value of the stand becomes smaller toward the rear stage when the plurality of stands are temporarily operated before activation of the tandem rolling mill. Therefore, appropriate tension is applied to the rolled material between the adjacent stands while a load corresponding to the mechanical rattle of the plurality of stands is absorbed. As a result, it is possible to more surely prevent rupture of the rolled material.

### BRIEF DESCRIPTION OF DRAWINGS

FIG. 1 is a configuration diagram of a cold tandem rolling mill to which a control apparatus of a tandem rolling mill according to an embodiment 1 is applied.

FIG. 2 is a block diagram of the control apparatus of the tandem rolling mill according to the embodiment 1.

FIG. 3 is a diagram illustrating a speed command value, a speed response value, a tension response value, and a Droop set value before and after the cold tandem rolling mill is activated by the control apparatus of the tandem rolling mill according to the embodiment 1.

FIG. 4 is a diagram illustrating a Droop amount table that is used by a Droop amount setting unit in the control apparatus of the tandem rolling mill according to the embodiment 1.

FIG. 5 is a diagram illustrating the speed command value and the Droop amount set value when the cold tandem rolling mill is stopped by the control apparatus of the tandem rolling mill according to the embodiment 1.

FIG. 6 is a diagram illustrating a Droop gain circuit provided in the Droop amount setting unit in the control apparatus of the tandem rolling mill according to the embodiment 1.

FIG. 7 is a hardware configuration diagram of the control apparatus of the tandem rolling mill according to the embodiment 1.

### DESCRIPTION OF EMBODIMENTS

An embodiment of the present invention is described with reference to accompanying drawings. Note that, in the drawings, identical or equivalent parts are denoted by the same reference numerals. Overlapped description of the parts is simplified or omitted as necessary.

### Embodiment 1

FIG. 1 is a configuration diagram of a cold tandem rolling mill to which a control apparatus of a tandem rolling mill according to an embodiment 1 is applied.

In the cold tandem rolling mill in FIG. 1, a plurality of stands 1 are arranged in a horizontal direction. Each of the plurality of stands 1 includes paired work rolls 2 and a plurality of backup rolls 3. A plurality of motors 4 are provided corresponding to the plurality of stands 1. A plurality of drive devices 5 are electrically connected to the respective motors 4. A control apparatus 6 is electrically connected to the plurality of drive devices 5.

The control apparatus 6 outputs a speed command value to each of the plurality of drive devices 5. Each of the plurality of drive devices 5 rotates the corresponding motor 4 based on the speed command value from the control apparatus 6. In each of the plurality of stands 1, the paired work rolls 2 are rotated following rotation of the corresponding motor 4. The plurality of backup rolls 3 are rotated following the paired work rolls 2. As a result, a rolled material 7 is rolled in an arrow direction.

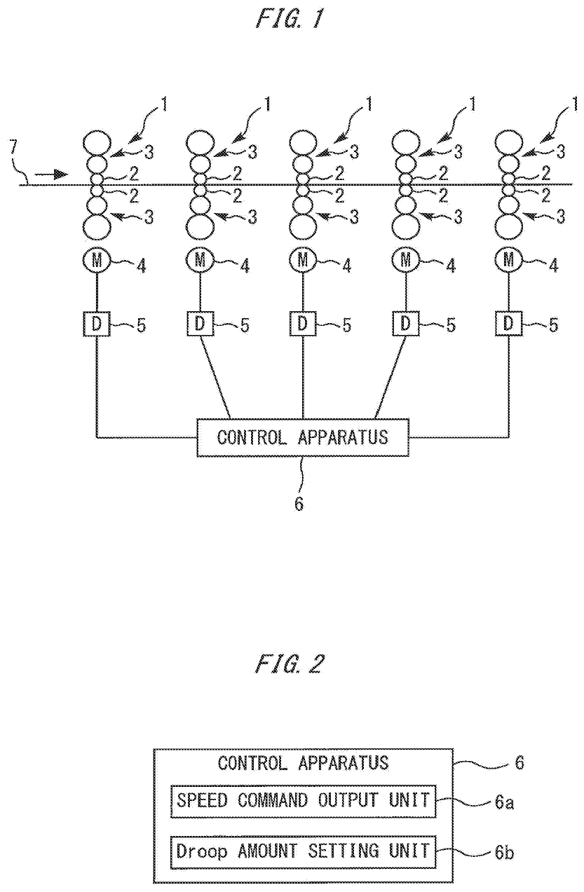

Next, the control apparatus 6 is described with reference to FIG. 2.

FIG. 2 is a block diagram of the control apparatus of the tandem rolling mill according to the embodiment 1.

As illustrated in FIG. 2, the control apparatus 6 includes a speed command output unit 6a and a Droop amount setting unit 6b.

The speed command output unit 6a outputs the speed command value to each of the plurality of stands 1. The Droop amount setting unit 6b outputs a Droop amount set value to each of the plurality of stands 1. As a result, loads applied to the plurality of stands are balanced.

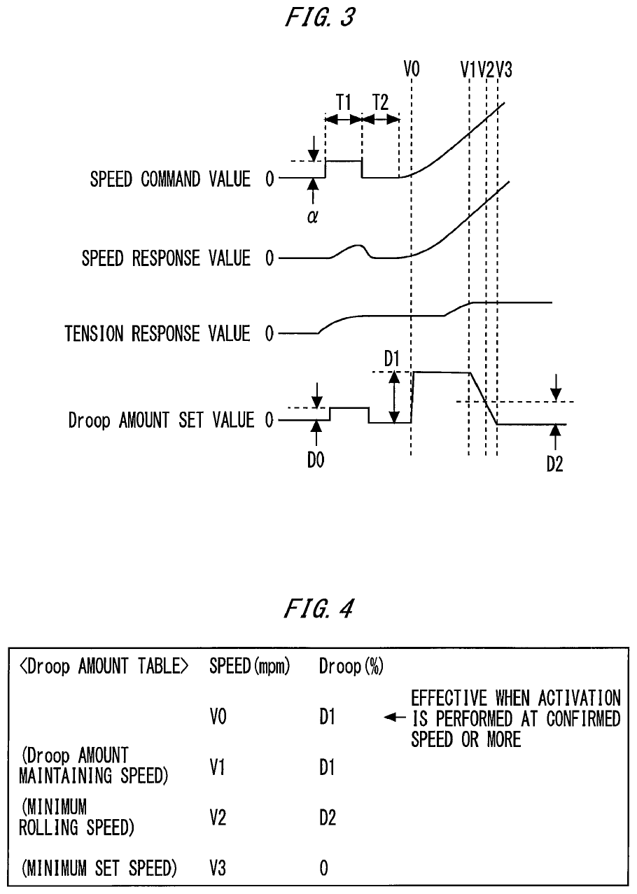

Next, speed control before and after the cold tandem rolling mill is activated is described with reference to FIG. 3.

FIG. 3 is a diagram illustrating the speed command value, a speed response value, a tension response value, and the Droop set value before and after the cold tandem rolling mill is activated by the control apparatus of the tandem rolling mill according to the embodiment 1.

As illustrated in FIG. 3, in a time period T1 before the cold tandem rolling mill is activated, the speed command output unit 6a temporarily outputs a step-shaped speed command value a to each of the plurality of stands 1. For example, the speed command output unit 6a temporarily outputs the speed command value of 1% of a set speed to each of the plurality of stands 1. As a result, in each of the plurality of stands 1, the paired work rolls 2 are rotated in response to the speed command value. The rotation speed at this time is detected as the speed response value.

During the period in which the speed command output unit 6a temporarily outputs the step-shaped speed command value a, the Droop amount setting unit 6b outputs a Droop set value D0 to each of the plurality of stands 1. At this time, the Droop amount setting unit 6b sets the Droop amount set amount D0 of the stand 1 smaller toward the rear stage. As a result, appropriate tension is applied to the rolled material 7 between the adjacent stands 1 while the load corresponding to mechanical rattle of the plurality of stands 1 is absorbed.

In a subsequent time period T2, the Droop amount setting unit 6b outputs a Droop amount set value 0 in consideration of necessity of torque for activation because of static friction of bearings of the backup rolls 3.

After the time period T2 elapses, the speed command output unit 6a outputs the speed command value for simultaneous activation to all of the plurality of stands 1. At this time, a speed PI successive control is performed in consideration of difference in static friction coefficients of the bearings of the backup rolls 3 among the plurality of stands 1. More specifically, a difference between the tension response value and a tension reference value of the rolled material between the adjacent stands 1 is suppressed. For example, in a case where the rolled material is slightly pulled, when the speed command value of each of the stands 1 is increased, the rolled material is loosened. For example, in a case where the rolled material is slightly loosened, when the speed command value of each of the stands 1 is reduced, the rolled material is pulled.

Thereafter, at a time when the speed response value becomes a start-completion speed Vo in each of the plurality of stands 1, the Droop amount setting unit 6b outputs a Droop amount set value D1. At this time, the Droop amount set value D1 is set to a value larger than the Droop amount set value D0. Thereafter, the Droop amount setting unit 6b maintains the Droop amount set value D1 until the speed command value becomes a Droop amount maintaining speed V1.

Thereafter, the Droop amount setting unit 6b gradually reduces the Droop amount set value until the speed command value becomes a minimum set speed V3 through a minimum rolling speed V2. More specifically, when the speed command value indicates the minimum rolling speed V2, the Droop amount setting unit 6b outputs the Droop amount set value D2. When the speed command value indicates the minimum set speed V3, the Droop amount setting unit 6b outputs the Droop amount set value 0. As a result, unbalancing of the speed due to the mechanical rattle among the plurality of stands 1 is suppressed in a low speed range, and appropriate tension is maintained on the rolled material 7 between the adjacent stands 1.

Next, a Droop amount setting method by the Droop amount setting unit 6b is described with reference to FIG. 4.

FIG. 4 is a diagram illustrating a Droop amount table that is used by the Droop amount setting unit in the control apparatus of the tandem rolling mill according to the embodiment 1.

As illustrated in FIG. 4, information on the speed and information on the Droop amount are associated with each other in the Droop amount table. For example, information on the speed “V0” and information on the Droop amount “D1” are associated with each other. For example, information on the speed “V1” and information on the Droop amount “D1” are associated with each other. For example, information on the speed “V2” and information on the Droop amount “D2” are associated with each other. For example, information on the speed “V3” and information on the Droop amount “0” are associated with each other.

The Droop amount setting unit 6b determines the Droop amount set value based on the information in the Droop amount table. More specifically, the Droop amount setting unit 6b sets the Droop amount set value to “D1” when the speed command value is within a range from “V0” to “V1”. The Droop amount setting unit 6b sets the Droop amount set value to “D2” when the speed command value indicates “V2”. The Droop amount setting unit 6b sets the Droop amount set value to “0” when the speed command value indicates “V3”.

Next, speed control when the cold tandem rolling mill is stopped is described with reference to FIG. 5.

FIG. 5 is a diagram illustrating the speed command value and the Droop amount set value when the cold tandem rolling mill is stopped by the control apparatus of the tandem rolling mill according to the embodiment 1.

As illustrated in FIG. 5, when the speed command value in the Droop amount table is within the range from “V1” to “V0” immediately before the cold tandem rolling mill is stopped, the Droop amount setting unit 6b adds a constant value β to the Droop amount set value “D1”. As a result, unbalancing of the speed due to the mechanical rattle among the plurality of stands 1 is suppressed in the low speed range, and appropriate tension is maintained on the rolled material 7 between the adjacent stands 1.

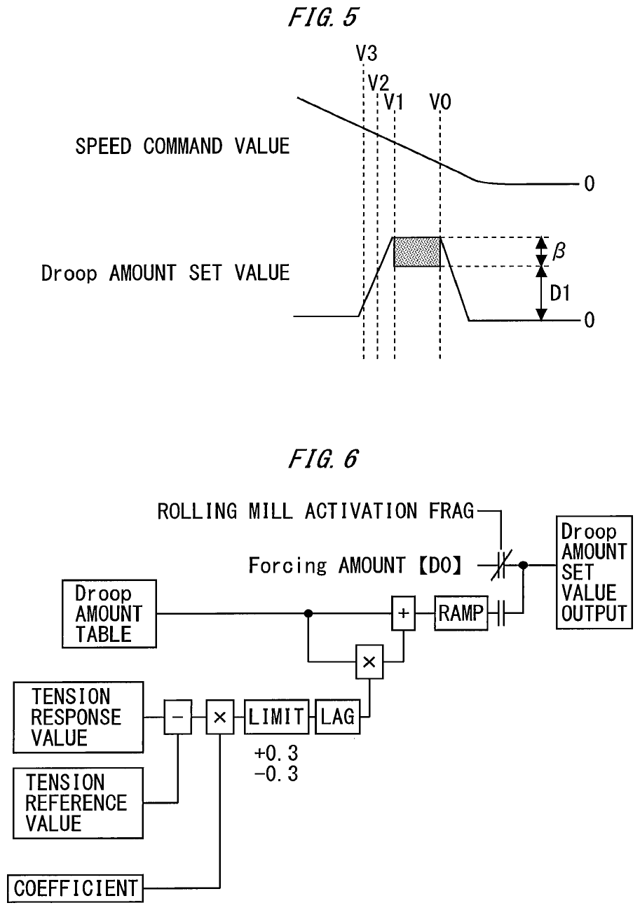

Next, adjustment of the Droop amount set value by the Droop amount setting unit 6b is described with reference to FIG. 6.

FIG. 6 is a diagram illustrating a Droop gain circuit provided in the Droop amount setting unit in the control apparatus of the tandem rolling mill according to the embodiment 1.

As illustrated in FIG. 6, the Droop amount setting unit 6b multiplies the difference between the tension response value and the tension reference value by a coefficient to obtain a gain until the tension on the rolled material 7 becomes stable and the tension control is started after the cold tandem rolling mill is started. The Droop amount setting unit 6b sets a value that is obtained by multiplying the value obtained from the Droop amount table by the gain, as the Droop amount set value.

In this case, when the tension response value is smaller than the tension reference value between the adjacent stands 1, the Droop amount set value becomes smaller than the value obtained from the Droop amount table. In contrast, when the tension response value is larger than the tension reference value between the adjacent stands 1, the Droop amount set value becomes larger than the value obtained from the Droop amount table. As a result, unbalancing of the speed between the adjacent stands 1 is suppressed, and appropriate tension is maintained on the rolled material 7 between the adjacent stands 1.

According to the embodiment 1 described above, in the cold tandem rolling mill in the state where the plurality of stands 1 each sandwich the rolled material 7, the Droop amount setting unit 6b sets the Droop amount set value of the stand smaller toward the rear stage during the period in which the speed command output unit 6a temporarily outputs the speed command value. More specifically, the Droop amount set value is set so as to be inversely proportional to the speed of the stand 1 on the rear-stage side based on the speed of the stand 1 on the front-stage side. In this case, appropriate tension is applied to the rolled material 7 between the adjacent stands 1 while the load corresponding to the mechanical rattle of the plurality of stands 1 is absorbed. As a result, it is possible to more surely prevent rupture of the rolled material.

Further, the Droop amount setting unit 6b varies the Droop amount of each of the plurality of stands 1 based on the speed of each of the plurality of stands 1 after the cold tandem rolling mill is started, and adds the constant value β to the Droop amount set value corresponding to the speed of each of the plurality of stands 1 immediately before the cold tandem rolling mill is stopped. Accordingly, it is possible to suppress unbalancing of the speed due to the mechanical rattle among the plurality of stands 1 in the low speed range, and to stop the cold tandem rolling mill while the tension on the rolled material 7 is appropriately maintained between the adjacent stands 1. As a result, it is possible to more surely prevent rupture of the rolled material 7 when the cold tandem rolling mill is reactivated.

Note that control similar to the control according to the embodiment may be performed on a cold tandem rolling mill subjected to torque control. Also in this case, it is possible to more surely prevent rupture of the rolled material 7.

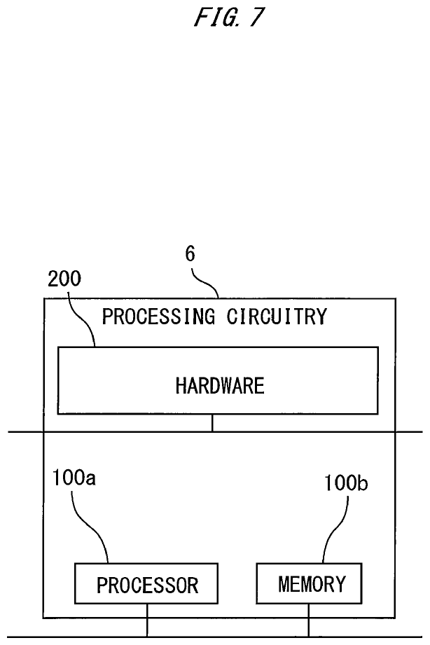

Next, an example of the control apparatus 6 is described with reference to FIG. 7.

FIG. 7 is a hardware configuration diagram of the control apparatus of the tandem rolling mill according to the embodiment 1.

Functions of the control apparatus 6 may be implemented by a processing circuitry. For example, the processing circuitry includes at least one processor 100a and at least one memory 100b. For example, the processing circuitry includes at least one dedicated hardware 200.

When the processing circuitry includes the at least one processor 100a and the at least one memory 100b, the functions of the control apparatus 6 are implemented by software, firmware, or a combination of software and firmware. At least one of the software and the firmware is described as a program. At least one of the software and the firmware is stored in the at least one memory 100b. The at least one processor 100a reads and executes the program stored in the at least one memory 100b to implement the functions of the control apparatus 6. The at least one processor 100a is also referred to as a central processing unit, a processing device, a calculation device, a microprocessor, a microcomputer, or a DSP. For example, the at least one memory 100b is a nonvolatile or volatile semiconductor memory such as a RAM, a ROM, a flash memory, an EPROM, and EEPROM, a magnetic disk, a flexible disk, an optical disk, a compact disc, a mini disc, or a DVD.

When the processing circuitry includes the at least one dedicated hardware 200, the processing circuitry is implemented by, for example, a single circuitry, a composite circuitry, a programmed processor, a parallel-programmed processor, an ASIC, an FPGA, or a combination thereof. For example, the functions of the control apparatus 6 is individually implemented by the processing circuitry. For example, the functions of the control apparatus 6 are collectively implemented by the processing circuitry.

A part of the functions of the control apparatus 6 may be implemented by the dedicated hardware 200, and the other part may be implemented by the software or the firmware. For example, the function of the Droop amount setting unit 6b may be implemented by the processing circuitry as the dedicated hardware 200, and the functions other than the function of the Droop amount setting unit 6b may be implemented by causing the at least one processor 100a to read and execute the program stored in the at least one memory 100b.

As described above, the processing circuitry implements the functions of the control apparatus 6 by the hardware 200, the software, the firmware, or a combination thereof.

### INDUSTRIAL APPLICABILITY

As described above, the control apparatus of the tandem rolling mill according to the present invention is usable in the tandem rolling mill.

### REFERENCE SIGNS LIST

1 Stand
2 Work roll
3 Backup roll
4 Motor
5 Drive device
6 Control apparatus
6a Speed command output unit
6b Droop amount setting unit
100a Processor
100b Memory
200 Hardware

1. A control apparatus of a tandem rolling mill, comprising:
a speed command output unit configured to temporarily output a speed command value to each of a plurality of stands before a tandem rolling mill is activated while in a state where a rolled material is sandwiched between the plurality of stands; and
a Droop amount setting unit configured to set a Droop amount set value of the stand smaller toward rear stage of the plurality of stands, during a period in which the speed command output unit temporarily outputs the speed command value.

2. The control apparatus of the tandem rolling mill according to claim 1, wherein
the speed command output unit outputs the speed command value to suppress difference between a tension response value and a tension reference value of the rolled material between the adjacent stands after the tandem rolling mill is started, and
the Droop amount setting unit varies the Droop amount set value of each of the plurality of stands based on a speed of each of the plurality of stands after the tandem rolling mill is started, and adds a constant value to the Droop amount set value corresponding to the speed of each of the plurality of stands immediately before the tandem rolling mill is stopped.

3. A control apparatus of a tandem rolling mill, comprising:
a speed command output unit configured to output a speed command value to suppress difference between a tension response value and a tension reference value of a rolled material between adjacent stands after a tandem rolling mill in a state where a plurality of stands each sandwich the rolled material is started; and
a Droop amount setting unit configured to vary a Droop amount of each of the plurality of stands based on a speed of each of the plurality of stands after the tandem rolling mill is started, and to add a constant value to the Droop amount set value corresponding to the speed of each of the plurality of stands immediately before the tandem rolling mill is stopped.

4. The control apparatus of the tandem rolling mill according to claim 1, wherein the Droop amount setting unit sets, as the Droop amount set value, a value that is obtained by multiplying a value obtained from a Droop amount table by a gain until tension control is started after the tandem rolling mill is started, the value obtained from the Droop amount table being varied based on the speed of each of the plurality of stands, the gain corresponding to the difference between the tension response value and the tension reference value of the rolled material between the adjacent stands.

5. A control apparatus of a tandem rolling mill, comprising:
a torque command output unit configured to temporarily output a torque command value to each of a plurality of stands before a tandem rolling mill is activated while in a state where a rolled material is sandwiched between the plurality of stands; and
a Droop amount setting unit configured to set a Droop amount set value of the stand smaller toward rear stage of the plurality of stands, during a period in which the torque command output unit temporarily outputs the torque command value.

6. The control apparatus of the tandem rolling mill according to claim 5, wherein
the torque command output unit outputs the torque command value to suppress difference between a tension response value and a tension reference value of the rolled material between the adjacent stands after the tandem rolling mill is started, and
the Droop amount setting unit varies the Droop amount set value of each of the plurality of stands based on a torque of each of the plurality of stands after the tandem rolling mill is started, and adds a constant value to the Droop amount set value corresponding to the torque of each of the plurality of stands immediately before the tandem rolling mill is stopped.

7. A control apparatus of a tandem rolling mill, comprising:
a torque command output unit configured to output a torque command value to suppress difference between a tension response value and a tension reference value of a rolled material between adjacent stands after a tandem rolling mill in a state where a plurality of stands each sandwich the rolled material is started; and
a Droop amount setting unit configured to vary a Droop amount of each of the plurality of stands based on a torque of each of the plurality of stands after the tandem rolling mill is started, and to add a constant value to the Droop amount set value corresponding to the torque of each of the plurality of stands immediately before the tandem rolling mill is stopped.

8. The control apparatus of the tandem rolling mill according to claim 5, wherein the Droop amount setting unit sets, as the Droop amount set value, a value that is obtained by multiplying a value obtained from a Droop amount table by a gain until tension control is started after the tandem rolling mill is started, the value obtained from the Droop amount table being varied based on the torque of each of the plurality of stands, the gain corresponding to the difference between the tension response value and the tension reference value of the rolled material between the adjacent stands.
